(19) United States
(12) Patent Application Publication
(10) Pub. No.: US 2016/0379131 A1
(43) Pub. Date: Dec. 29, 2016

(54) FUZZY OPAQUE PREDICATES

(71) Applicant: NXP B.V., Eindhoven (NL)

(72) Inventor: Philippe Teuwen, Louvain (BE)

(21) Appl. No.: 14/751,606

(22) Filed: Jun. 26, 2015

(51) Int. Cl. G06N 7/02; G06F 9/30

(52) U.S. Cl. CPC G06N 7/02; G06F 9/3001

(57) ABSTRACT

Disclosed are secure processes based upon fuzzy opaque predicates and machines such as processors and non-transitory machine-readable storage mediums encoded with instructions containing fuzzy opaque predicates.

### FIELD

Embodiments disclosed relate generally to secure processes and machines equipped with secure processes, and more specifically to processes which may include opaque predicates and machines, such as processors, equipped with processes including opaque predicates.

### BACKGROUND

A predicate in an expression in a computer program controls flow of the program depending upon whether the expression is true or false. Those concerned with computer program security often seek to create programs which are difficult to reverse-engineer or reverse-compile. Opaque predicates are expressions which may be found in computer programs that are always true or false, but which, nevertheless, must be evaluated at run-time. Typically, an opaque predicate evaluates to true or false in a non-apparent way, so that it is difficult for automated tools to simplify the superfluous conditions of the predicate. Opaque predicates may be inserted into computer programs to thwart symbolic execution solvers, or reverse-compiling. They may also be used to obfuscate a loop condition or watermark code. They may also be used to prevent a reverse compiler from optimizing away a portion of the computer code.

### SUMMARY

Illustrative embodiments disclosed herein include: a non-transitory machine-readable storage medium encoded with instructions for operation of a processor, said instructions comprising: at least one instruction of the form: “if [statement] then do A else do B”; wherein said statement is a fuzzy opaque predicate, the truth or falsity (T or F) of which statement depending upon a range of input values, said statement having a single value (T or F) for all expected input values. In some circumstances, and for all embodiments, the various statement(s) may have a single value for all reasonably expected input values or for some statistically-determined range of input values, such as 99.99% 98% or 95%. (if certain errors are tolerable).

A further embodiment includes: the non-transitory machine readable storage medium of presented above and further including an instruction of the form: “if [statement] then do A else do B”, in which said statement is mathematically true or false (T or F), but which nevertheless has the opposite value (F or T) when evaluated on said processor due to computational limitations of said processor.

Yet a further embodiment includes: the first-disclosed non-transitory machine readable storage medium, further including an instruction of the form: “if [statement] then do A else do B”, in which said statement includes a comparison between the value of a mathematical function and a truncated series expansion of the same function, which comparison is always either true or false (T or F).

Another embodiment includes: a method comprising controlling a server to, upon request from a user device, facilitate the transfer of instructions for operation of a processor on said user device, said server containing a non-transitory machine readable storage medium as described in the first embodiment or the second embodiment or the third embodiment.

Although the appended claims are directed to particular combinations of features, it should be understood that the scope of the disclosure also includes any novel feature or novel combination of features disclosed herein.

Features which are described in the context of separate embodiments may also be provided in combination in a single embodiment. Conversely, various features which are, for brevity, described in the context of a single embodiment, may also be provided separately or in any suitable sub-combination.

### BRIEF DESCRIPTION OF THE DRAWINGS

FIG. 1 is a block diagram showing various illustrative embodiments.

### DETAILED DESCRIPTION OF EMBODIMENTS

Those concerned with the development of secure processes, including computer programs have continually sought improved ways of combating reverse engineering.

Traditional opaque predicates do not resist mathematical analysis because they are mathematically provable statements, for example, consider the statement:

∀x,y ∈ Z: 7y²−1≠x²

A computer program might embody the above statement as follows:

“if (varx*varx==argy*argy*7−1) then do A else do B”

where varx and argy are two arbitrary variables or arguments of the program.

A good automated solver could rewrite the above statement as simply:

“do B”

In an effort to make the reverse engineering of opaque predicates more problematic for the attacker, we may construct “fuzzy” opaque predicates which, generally speaking, may be viewed as predicates which are not strictly always true or false or which lead to results which are different from what the underlying mathematics suggests. A variety of embodiments are disclosed below.

In a first embodiment, an opaque predicate may be constructed to take advantage of processor limitations. Such a predicate expression need not be true ∀x ∈ Z but ∀x ∈ [−2147483648 . . . 2147483647]. An example might be:

(2³³)^{1/33}==2.

The foregoing statement may be mathematically true, but will be false when evaluated on a 32-bit processor without a bignum library.

Under some circumstances, an automated solver may be equipped to take into the constraints of the processing architecture and may be able to efficiently reverse engineer the foregoing predicate.

In another set of embodiments, operations may be performed on floats and take advantage of the imprecision of float representation in CPU architectures. By way of example, it can be noted that the statement:

(0.1)²==0.01

is mathematically true, but the statement, nevertheless, is false when evaluated on a 24-bit floating point unit.

By way of another, but similar example, it can be noted that use may be made of irrationals e.g. π or e in a statement such as:

sin(π)==0.

The foregoing statement is mathematically true, but becomes false when evaluated on a single or double precision floating point unit.

A yet further, but similar example is the following: While floating-point addition and multiplication are both commutative (e.g. a+b=b+a, and a×b=b×a), they are not necessarily associative. That is, (a+b)+c is not necessarily equal to a+(b+c). For example the below statement:

(1234.567+45.67834)+0.0004==1234.567+(45.67834+0.0004)

is mathematically true, but is false when evaluated using 7-digit mantissa decimal arithmetic. It may be observed that generally speaking, two computational sequences that are mathematically equal may often produce different floating-point values. Thus, for the preceding three examples, each may be resolved by a solver as being true, while the predicates will be resolved as false when executed on a targeted microprocessor.

It is believed that the use of fuzzy opaque predicates which are based upon use of floats is much harder for a solver to handle.

Yet another set of embodiments can be obtained by computing approximations of expressions, for example, computing a few terms of a Taylor series rather than relying on a standard math library call. For example, consider the expression:

∀x ∈ ]−1 . . . 1[, sin(x)−x+x³/3!−x⁵/5!+x⁷/7<0.000003.

Such an inequality when used as the basis for an opaque predicate will be more difficult for a solver to handle. The above comparison between a mathematical function and a truncated series expansion may utilize a wide variety of functions, such as trigonometric or logarithmic functions or Bessel or Legendre functions or any function which can be also be approximated by a series expansion.

Another set of embodiments can be constructed which are more probabilistic within the processing architecture range if one is willing to tolerate very rare exceptions. An example is an obfuscated predicate which will be true for all possible values except one value will be correctly executed in 99.999999977% of cases if applied on a uniformly randomized 32-bit input and might be even correct in 100% of cases, if the programmer has a knowledge of the actual range of the input data and understands that in normal conditions the input values will never take some values. Thus, for example, the statement:

if (argx==0x12345678) then do A else do B

will, in practice work as “do B” with a possible but rare probability of “do A” or even a null probability if one knows that argx will never be >0x10000000.

Thus, there has been described a variety of statements which may be termed “fuzzy opaque predicates” which are opaque predicates which may be either true or false depending upon the circumstances of their evaluation. Such fuzzy opaque predicates may be, for example, true in a mathematical sense, but false when evaluated on a particular processor. The falsity of the statement when evaluated on a particular processor may be due to, for example, processor limitations, such as limitations on the size of the integers or numbers that the processor can handle, or limitations on the accuracy of the processor's floating point unit. In addition, the truth or falsity of the statement may depend upon the range of expected input values and the statement may be true for a large set of predetermined input values, while false for a much smaller set of predetermined input values.

It is possible to combine some of the concepts disclosed to create even more secure fuzzy opaque predicates. For example, one may create a fuzzy opaque predicate having more than two or more parts. For example, one part may be a statement which, as mentioned above, the truth or falsity of which depends upon the range of input values (the statement being, for example, true for a large set of predetermined input values, which false for a much smaller set of predetermined input values). The second part may be a statement which, as mentioned above, is mathematically true, but becomes false when evaluated on a single or double precision floating point unit (or upon whatever processor the instruction is operating upon). An alternative second part (or a third part) may be a statement which, as mentioned above, requires a comparison of a known value against a complex mathematical expression which comparison always gives the same result.

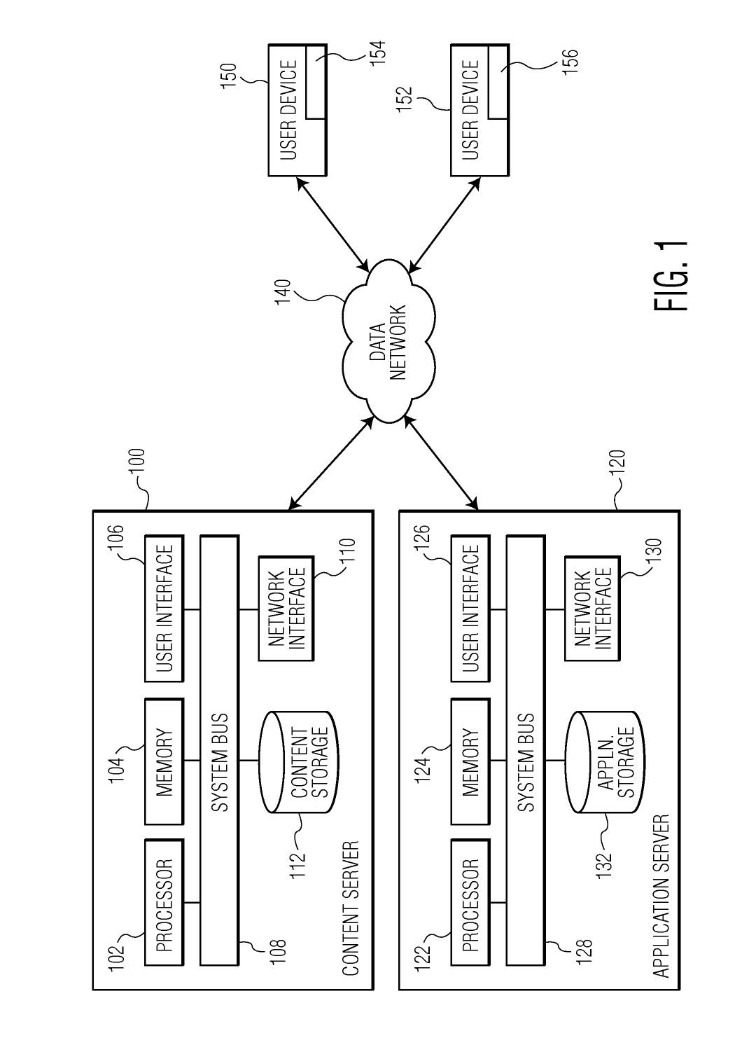

Enhanced security may be obtained with processors and non-transitory machine-readable storage media which contain instructions with fuzzy opaque predicates as described above and reverse engineering or reverse compiling thereby being made more difficult. Thus, sets of instructions containing fuzzy opaque predicates which are more secure against such attacks may be stored and transmitted to a wide variety of users. For example, in FIG. 1, there is shown a content server 100, application server 120, user devices 150 and 152, and a data network 140. The user devices 150, 152 may request access to instructions or content (which contains fuzzy opaque predicates) provided by the content server 100 via data network 140. The data network can be any data network providing connectivity between user devices 150, 152, and the content server 100 and the application server 120. User devices 150 and 152 may be one of a plurality of devices, for example, set top boxes, media streamers, digital video recorders, tablets, mobile phones, laptop computers, portable media devices, smart watches, desktop computers, media servers, etc.

The user request for access may first require the downloading of a software application that may be used to process the content provided by the content server 100. The software application may contain fuzzy opaque predicates as herein described. After the user devices 150, 152 install the software application, the user device may then download content (which may also contain fuzzy opaque predicates) from the content server 100. In some cases, the downloaded software application may perform decryption of encrypted content received from the content server.

The content server 100 may control the access to the content provided to the user devices 150, 152. As a result when the content server 100 receives a request for content, the content server 100 may transmit the content to the requesting user device. Similarly, the application server 120 may control access to the software application provided to the user devices 150, 152. Consequently, when the content server 120 receives a request for the software application, the application server 120 may transmit the application to the requesting user device.

The content server 100 may include a processor 102, memory 104, user interface 106, network interface 110, and content storage (non-transitory machine readable storage medium), interconnected via one or more system buses 180. It will be understood that FIG. 1 constitutes, in some respects, an abstraction and that the actual organization of the components of server 100 may be more complex than illustrated.

Processor 102 may be any hardware device capable of executing instructions stored in memory 104 or storage (non-transitory machine-readable storage medium) 112. As such, the processor may include a microprocessor field programmable gate array (FPGA), application-specific integrated circuits (ASICs), or other similar devices.

The various memories, 104, 124 and storages 112 and 132 (non-transitory machine-readable storage media) may include various memories, such as, for example, cache or system memories. They may be comprised of static random access memories (SRAMs), dynamic RAM (DRAM), flash memory, read only memory (ROM), or other similar memory devices, such as magnetic disk storage media, optical storage media, etc.

The user interface 106 may include one or more devices for enabling communication with a user such as an administrator. For example, the user interface 106 may include a display, a mouse, and a keyboard for receiving user commands.

The network interface 110 may include one or more devices for enabling communication with other hardware devices. For example, the network interface 110 may include a network interface card (NIC) configured to communicate according to the Ethernet protocol. Additionally, the network interface 110 may implement a TCP/IP stack for communication according to the TCP/IP protocols. Various alternative or additional hardware or configurations for network interface 110 are possible.

The application server 120 includes elements like those in the content server 100 and the description of the like elements in the content server 100 apply to the application server 120. It is further noted that the content server 100 and application server 120 may be implemented on a single server. Further, such servers may be implemented on a distributed computer system as well as on cloud computer systems.

As used herein, the term “non-transitory machine-readable storage medium” will be understood to exclude a transitory propagating signal, but to include all forms of volatile and non-volatile memory. Further, as used herein, the term “processor” will be understood to encompass a variety of devices such as microprocessors, field-programmable gate arrays (FPGAs), application-specific integrated circuits (ASICs) and other similar processing devices. When software is implemented on a processor, the combination becomes a single specific machine.

Thus, instructions for operation of a processor having the fuzzy opaque predicates as described above may be stored, for example, in locations 104, 112, 124, or 132. Such instructions may be employed to operate processors 102 or 122. Furthermore, user devices 150 or 152 may request, via network 140, the opportunity to download a variety of instructions (illustratively, in the form of applications or content) which have the fuzzy opaque predicates as described above from servers 100 or 120, thereby storing such instructions on local memories 154 or 156 for subsequent execution.

Various illustrative embodiments are described in reference to specific illustrative examples. The illustrative examples are selected to assist a person of ordinary skill in the art to form a clear understanding of, and to practice the various embodiments. However, the scope of systems, structures and devices that may be constructed to have one or more of the embodiments, and the scope of methods that may be implemented according to one or more of the embodiments, are in no way confined to the specific illustrative examples that have been presented. On the contrary, as will be readily recognized by persons of ordinary skill in the relevant arts based on this description, many other configurations, arrangements, and methods according to the various embodiments may be implemented.

To the extent positional designations such as top, bottom, upper, lower have been used in describing this invention, it will be appreciated that those designations are given with reference to the corresponding drawings, and that if the orientation of the device changes during manufacturing or operation, other positional relationships may apply instead. As described above, those positional relationships are described for clarity, not limitation.

The present invention has been described with respect to particular embodiments and with reference to certain drawings, but the invention is not limited thereto, but rather, is set forth only by the claims. The drawings described are only schematic and are non-limiting. In the drawings, for illustrative purposes, the size of various elements may be exaggerated and not drawn to a particular scale. It is intended that this invention encompasses inconsequential variations in the relevant tolerances and properties of components and modes of operation thereof. Imperfect practice of the invention is intended to be covered.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps.

What is claimed is:

1. A non-transitory machine-readable storage medium encoded with instructions for operation of a processor, said instructions comprising:
at least one instruction of the form: “if [statement] then do A else do B”; wherein said statement is a fuzzy opaque predicate, the truth or falsity (T or F) of which statement depending upon a range of input values, said statement having a single value (T or F) for all expected input values.

2. The non-transitory machine readable storage medium of claim 1 further including an instruction of the form: “if [statement] then do A else do B”, in which said statement is mathematically true or false (T or F), but which nevertheless has the opposite value (F or T) when evaluated on said processor due to computational limitations of said processor.

3. The non-transitory machine readable storage medium of claim 1, further including an instruction of the form: “if [statement] then do A else do B”, in which said statement includes a comparison between the value of a mathematical function and a truncated series expansion of the same function, which comparison is always either true or false (T or F).

4. The non-transitory machine readable storage medium of claim 1, further including an instruction of the form: “if [statement] then do A else do B”, in which said statement includes a comparison between the value of a mathematical function and a truncated series expansion of the same function, which comparison is reliably either true or false (T or F) for all expected input values.

5. A method comprising controlling a server to, upon request from a user device, facilitate the transfer of instructions for operation of a processor on said user device, said server containing a non-transitory machine readable storage medium as claimed in claim 1.

6. A method comprising controlling a server to, upon request from a user device, facilitate the transfer of instructions for operation of a processor on said user device, said server containing a non-transitory machine readable storage medium as claimed in claim 2.

7. A method comprising controlling a server to, upon request from a user device, facilitate the transfer of instructions for operation of a processor on said user device, said server containing a non-transitory machine readable storage medium as claimed in claim 3.
